(19) United States
(12) Patent Application Publication
(10) Pub. No.: US 2014/0040823 A1
(43) Pub. Date: Feb. 6, 2014

(54) METHOD AND DEVICE FOR MULTI-WINDOW BROWSING

(71) Applicant: TENCENT TECHNOLOGY (SHENZHEN) COMPANY LIMITED, Shenzhen (CN)

(72) Inventors: YUEWEI FAN, Shenzhen (CN); MENG ZHOU, Shenzhen (CN); DING XIANG, Shenzhen (CN)

(73) Assignee: TENCENT TECHNOLOGY (SHENZHEN) COMPANY LIMITED, Shenzhen (CN)

(21) Appl. No.: 14/034,843

(22) Filed: Sep. 24, 2013

Related U.S. Application Data
(63) Continuation of application No. PCT/CN2013/080611, filed on Aug. 1, 2013.

(30) Foreign Application Priority Data
Aug. 3, 2012 (CN) 201210275229.7

(51) Int. Cl. G06F 3/0481

(52) U.S. Cl. CPC G06F 3/0481
USPC 715/804

(57) ABSTRACT

Multi-window browsing methods and devices are disclosed. A target-object selection control command can be received by a multi-window browsing device. The target-object selection control command can be issued according to each of one or more target objects selected to be added to a multi-window browsing interface. The multi-window browsing device can determine whether a number of the one or more target objects reaches a preset value and can start the multi-window browsing interface to simultaneously display the one or more target objects on the multi-window browsing interface, when the number of the one or more target objects is determined that reaches the preset value. An exemplary multi-window browsing device can include a receiving unit, a determining unit, and a display unit.

### CROSS-REFERENCES TO RELATED APPLICATIONS

This application is a continuation of PCT Patent Application No. PCT/CN2013/080611, filed on Aug. 1, 2013, which claims priority to Chinese Patent

Application No. CN201210275229.7, filed on Aug. 3, 2012, the entire contents of all of which are incorporated herein by reference.

### FIELD OF THE DISCLOSURE

The present disclosure relates to the field of window browsing technology and, more particularly, relates to methods and devices for multi-window browsing.

### BACKGROUND

Due to screen size, technical implementation, and other hardware and software limitations, conventional window browsing methods provided by browsers on mobile terminals such as iPad, aPad, notebook computers, tablet computers, POS (i.e., point of sale) devices, and computers on board vehicles, usually include visual-display-type multi-tab-switching windows. As illustrated in FIG. 1, when a new window is created, the new window is directly listed as a visible tab such as tabs 101, 103 and 105 illustrated in FIG. 1 and is arranged on an interface of a browser. A user can directly perform operations such as selecting, opening, and closing with respect to each of the tabs 101, 103 and 105.

However, the browser of a mobile terminal can only display one window at one time, and a user also can only perform relevant browsing operations with respect to one window that the user is currently browsing. Therefore, the conventional window browsing methods cannot satisfy user's needs of simultaneously managing multiple windows and simultaneously performing browsing operations with respect to multiple windows. For example, the conventional window browsing methods cannot satisfy user's needs for playing a video in one window and simultaneously browsing a web page in another window and thus is very inconvenient for a user to use.

### BRIEF SUMMARY OF THE DISCLOSURE

According to various embodiments, there is provided a multi-window browsing method. A target-object selection control command can be received by a multi-window browsing device. The target-object selection control command can be issued according to each of one or more target objects selected to be added to a multi-window browsing interface. The multi-window browsing device can determine whether a number of the one or more target objects reaches a preset value and can start the multi-window browsing interface to simultaneously display the one or more target objects on the multi-window browsing interface, when the number of the one or more target objects is determined that reaches the preset value.

According to various embodiments, there is also provided a multi-window browsing device. The multi-window browsing device can include a receiving unit, a determining unit, and a display unit. The receiving unit can be configured to receive a target-object selection control command. The target-object selection control command can be issued by a control unit according to each of one or more target objects selected to be added to a multi-window browsing interface. The determining unit can be configured to determine whether a number of the one or more target objects reach a preset value. The display unit can be configured to start the multi-window browsing interface and to simultaneously display the one or more target objects on the multi-window browsing interface, when the number of the one or more target objects is determined that reaches the preset value.

Other aspects or embodiments of the present disclosure can be understood by those skilled in the art in light of the description, the claims, and the drawings of the present disclosure.

### BRIEF DESCRIPTION OF THE DRAWINGS

The following drawings are merely examples for illustrative purposes according to various disclosed embodiments and are not intended to limit the scope of the present disclosure.

FIG. 1 is a schematic showing conventional browsing with multi-tab-switching windows;

FIG. 2 depicts an exemplary multi-window browsing method in accordance with various disclosed embodiments;

FIG. 3 depicts a schematic diagram illustrating selection of a target web page in accordance with various disclosed embodiments;

FIG. 4 depicts a schematic diagram illustrating a multi-window browsing interface in accordance with various disclosed embodiments;

FIG. 5 depicts an exemplary multi-window browsing device in accordance with various disclosed embodiments;

FIG. 6 depicts an exemplary environment incorporating certain disclosed embodiments; and

FIG. 7 depicts an exemplary server consistent with the disclosed embodiments.

### DETAILED DESCRIPTION

Reference will now be made in detail to exemplary embodiments of the disclosure, which are illustrated in the accompanying drawings. Wherever possible, the same reference numbers will be used throughout the drawings to refer to the same or like parts.

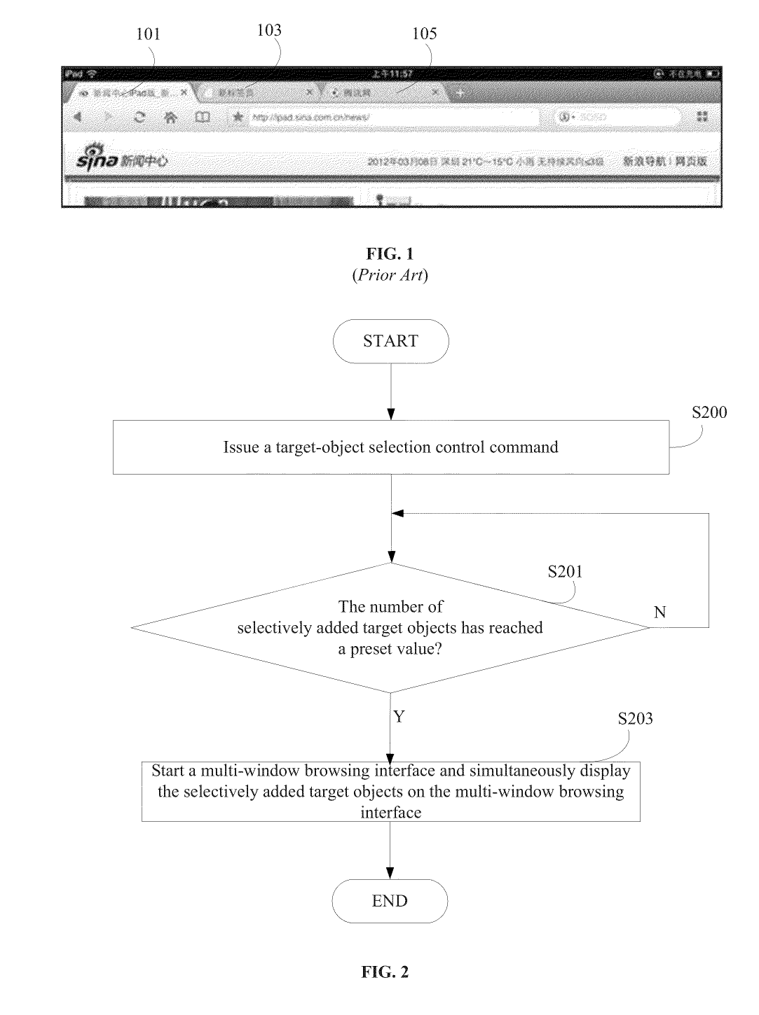

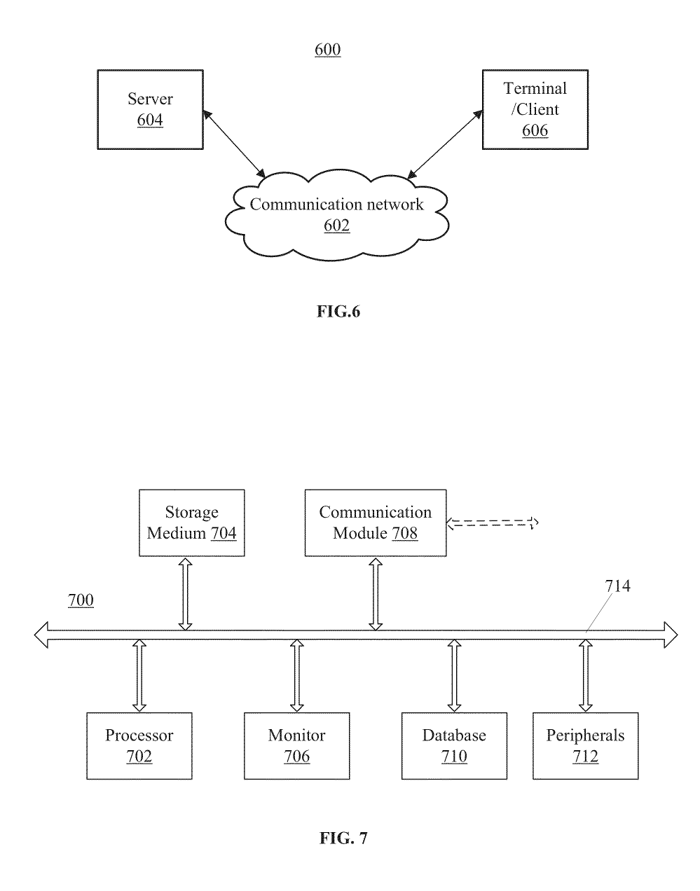

FIGS. 1-5 depict exemplary methods and devices for multi-window browsing in accordance with various disclosed embodiments. The exemplary methods and devices can be implemented, for example, in an exemplary environment 600 as shown in FIG. 6.

As shown in FIG. 6, the environment 600 can include a server 604, a terminal 606, and a communication network 602. The server 604 and the terminal 606 may be coupled through the communication network 602 for information exchange, for example, Internet searching, webpage browsing, etc. Although only one terminal 606 and one server 604 are shown in the environment 600, any number of terminals 606 or servers 604 may be included, and other devices may also be included.

The communication network 602 may include any appropriate type of communication network for providing network connections to the server 604 and terminal 606 or among multiple servers 604 or terminals 606. For example, the communication network 602 may include the Internet or other types of computer networks or telecommunication networks, either wired or wireless.

A terminal, as used herein, may refer to any appropriate user terminal device with certain computing capabilities, for example, a personal computer (PC), a work station computer, a notebook computer, a car computer (e.g., carrying in a car or other vehicles), a server computer, a hand-held computing device (a tablet computer), a mobile terminal (a mobile phone, a smart phone, an iPad, an aPad), a POS (i.e., point of sale) device, or any other user-side computing device. In various embodiments, the terms “terminal” and “terminal device” can be used interchangeably. In various embodiments, the terminal 606 can include a multi-window browsing device.

A server, as used herein, may refer one or more server computers configured to provide certain server functionalities, for example, search engines and database management. A server may also include one or more processors to execute computer programs in parallel.

The server 604 and the terminal 606 may be implemented on any appropriate computing platform. FIG. 7 shows a block diagram of an exemplary computing system 700 capable of implementing the server 604 and/or the terminal 606. As shown in FIG. 7, the exemplary computer system 700 may include a processor 702, a storage medium 704, a monitor 706, a communication module 708, a database 710, peripherals 712, and one or more bus 714 to couple the devices together. Certain devices may be omitted and other devices may be included.

The processor 702 can include any appropriate processor or processors. Further, the processor 702 can include multiple cores for multi-thread or parallel processing. The storage medium 704 may include memory modules, for example, ROM, RAM, and flash memory modules, and mass storages, for example, CD-ROM, U-disk, removable hard disk, etc. The storage medium 704 may store computer programs for implementing various processes, when executed by the processor 702.

Further, the peripherals 712 may include I/O devices, for example, keyboard and mouse, and the communication module 708 may include network devices for establishing connections through the communication network 602. The database 710 may include one or more databases for storing certain data and for performing certain operations on the stored data, for example, webpage browsing, database searching, etc.

In operation, the terminal 606 may cause the server 604 to perform certain actions, for example, an Internet search or other database operations. The server 604 may be configured to provide structures and functions for such actions and operations. More particularly, the server 604 may include a data searching system for real-time database searching. In various embodiments, a terminal, for example, a mobile terminal involved in the disclosed methods and systems can include the terminal 606.

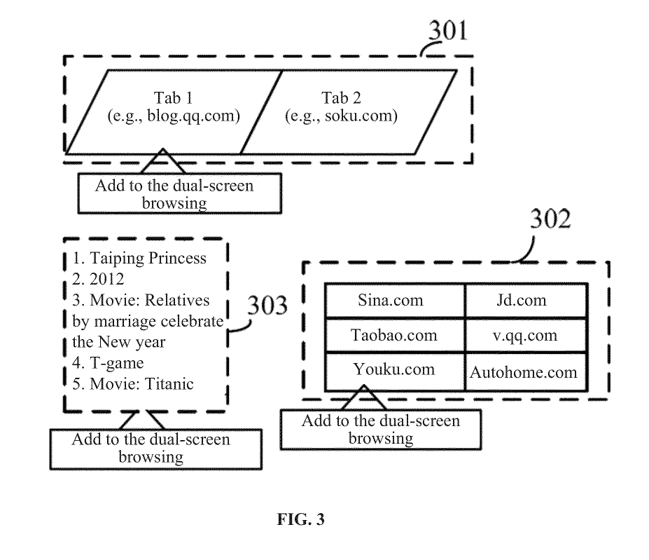

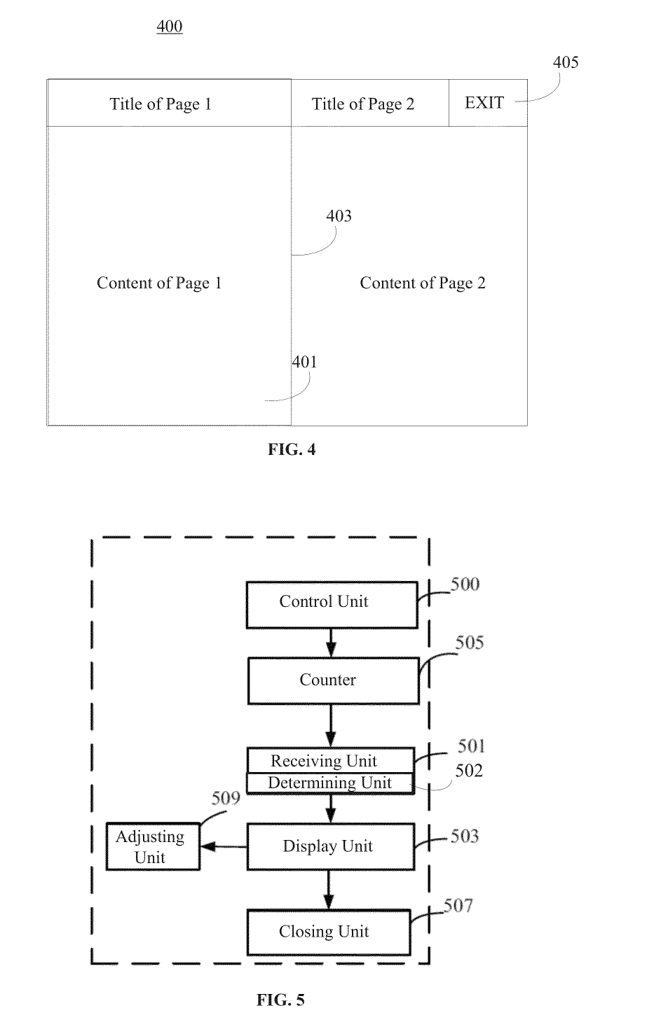

FIGS. 2-4 depict an exemplary multi-window browsing method in accordance with various embodiments. Specifically, FIG. 2 is a flowchart showing an exemplary multi-window browsing method; FIG. 3 is a schematic diagram illustrating selection of a target web page; and FIG. 4 is a schematic diagram illustrating a multi-window browsing interface.

In Step S200 of FIG. 2, based on a target object that is selected to add to a multi-window browsing interface, a corresponding target object-selection control command is issued.

In Step S201, the target object-selection control command is received and it is determined whether a number of selectively added target objects has reached a preset value. When a result of the determining is YES, i.e., when it is determined that a number of selectively added target objects has reached the preset value, the method then proceeds to perform Step S203. When the result of the determining is NO, i.e., when it is determined that a number of selectively added target objects has not reached the preset value, the method continues with Step S201.

In one embodiment, as illustrated in FIG. 3, a target object (e.g., a web page) can be selected from an already opened multi-tab list 301, a website guide 302, quick links 303, or links in a web page. For example, by pressing and/or holding a target object (e.g., the multi-tab list 301, the website guide 302, the quick links 303, or the links in a web page), an “add to dual-screen browsing” tab as illustrated in FIG. 3 can be popped up. By clicking the popped up “add to dual-screen browsing” tab, the corresponding target object-selection control command can be generated.

In various embodiments, Step 5201 can also include the following step: using a counter to count the number of the selectively added target objects (e.g., to count how many target objects are selected to be added) so as to obtain the number of the selectively added target objects.

For example, the number of the selectively added target objects can be obtained by obtaining a number of counts of the counter. In a case where the target objects are web pages, the number of counts of the counter can initially be set to be about 0. Every time a target object (e.g., a web page in this case) is selectively added, the number of counts of the counter is increased by 1. Assuming a total of two target web pages are added, the number of counts of the counter is 2. By obtaining the number of counts (e.g., which is 2 in this case) of the counter, the number (e.g., which is 2 in this case) of the selectively added target web pages can be obtained.

In Step S203, a multi-window browsing interface is started and the selectively added target objects are simultaneously displayed on the multi-window browsing interface.

FIG. 4 depicts an exemplary multi-window browsing interface. As illustrated in FIG. 4, the exemplary multi-window browsing interface 400 can include two browsing windows 401 and 402. Exemplary target objects are web pages; and exemplary preset value is 2. After the multi-window browsing interface 400 is started, contents of selectively added target web page 1 and target web page 2 can be respectively added to and displayed in the browsing windows 401 and 402. The browsing windows 401 and 402 can split the multi-window browsing interface into two halves. The contents of the target web page 1 and the target web page 2 can be any contents including, for example, videos, news, sports, and/or entertainment information. In other embodiments, the multi-window browsing interface can also include two or more browsing windows depending on actual needs, each of the browsing windows displaying one target object, thereby achieving an effect of simultaneously displaying two or more target objects.

In various embodiments, after Step S203, the above-described process can further include the following step: adjusting widths of windows displayed in the multi-window browsing interface when an interface adjustment control command is received. The exemplary multi-window browsing interface 400 shown in FIG. 4 can be used as an example to explain this adjusting step.

For example, when an interface adjustment control command, generated by a user by pressing the tab 403 at a border between the two browsing windows 401 and 402 and by dragging the tab 403 left or right, is received, displaying widths of the two browsing windows 401 and 402 can be adjusted accordingly. Specifically, when the tab 403 at the border between the browsing windows 401 and 402 is dragged left, the displaying width of the browsing window 401 can be narrowed and the displaying width of the browsing window 402 can be widened accordingly. When the tab 403 at the border between the browsing windows 401 and 402 is dragged right, the displaying width of the browsing window 401 can be widened and the displaying width of the browsing window 402 can be narrowed accordingly.

In various embodiments, after Step S203, the above-described process can further include the following step: closing the currently displayed multi-window browsing interface, restoring original browsing interfaces of the target objects, and clearing the counter, when a control command for closing the multi-window browsing interface is received.

The exemplary multi-window browsing interface 400 shown in FIG. 4 can be used as an example to explain this adjusting step. When a control command, generated by a user by touching an exit button 405 of the multi-window browsing interface and/or by other triggering methods, is received, the currently displayed multi-window browsing interface 400 can be closed and original browsing interface(s) of the target objects can be restored. In the case where the target objects are web pages, after closing the currently displayed multi-window browsing interface 400, each of the web pages can be restored to its original single web page display interface in the browser and each of the web pages can be listed as a visible tab for a user to select. When a user selects a tab, a window can be displayed. The user can only perform browsing operation with respect to one window that is currently displayed.

In one embodiment, when the number of selectively added target objects has reached a preset value, the multi-window browsing interface can be started and the selectively added target objects can be simultaneously displayed on the multi-window browsing interface. This allows a user to simultaneously manage multiple browsing windows and simultaneously perform relevant browsing operations with respect to multiple windows. For example, a user can play a video in one window and at the same time browse a web page in another window. This is more user-friendly.

FIG. 5 depicts an exemplary multi-window browsing device according to various disclosed embodiments. Referring to FIGS. 3-5, the exemplary multi-window browsing device can include a control unit 500, a receiving unit 501, a determining unit 502, and/or a display unit 503.

The control unit 500 can be used to issue a corresponding target object-selection control command based on a target object that is selectively added to a multi-window browsing interface.

For example, as illustrated in FIG. 3, a target object (e.g., a web page) can be selected from an already opened multi-tab list 301, a website guide 302, quick links 303, or links in a web page. For example, by pressing and holding a target object (e.g., the multi-tab list 301, the website guide 302, the quick links 303, or the links in a web page), an “add to dual-screen browsing” tab can be popped up. By clicking the popped up “add to dual-screen browsing” tab, the corresponding target object-selection control command can be generated.

The receiving unit 501 can be used to receive the target object-selection control command and the determining unit 502 can be used to determine whether a number of selectively added target objects has reached the preset value. When the number of selectively added target objects is determined that has not reached the preset value, the determining unit 502 can continue to perform the determining process.

The display unit 503 can be used to start a multi-window browsing interface when the number of selectively added target objects has reached the preset value and simultaneously display the selectively added target object(s) on the multi-window browsing interface.

In the exemplary multi-window browsing interface as illustrated in FIG. 4, the multi-window browsing interface 400 can include the two browsing windows 401 and 402; target objects can be web pages; and the preset value can be 2. The display unit 503 can start the multi-window browsing interface 400 and respectively add contents of the selected target web page 1 and target web page 2 to the browsing windows 401 and 402 to be displayed therein, the browsing windows 401 and 402 splitting the multi-window browsing interface into two halves or two sections. The browsing windows 401 and 402 can share the multi-window browsing interface. The contents of the target web page 1 and target web page 2 can be any contents including, for example, videos, news, sports, and entertainment contents. In other embodiments, the multi-window browsing interface can also include two or more browsing windows depending on the actual needs, each of the browsing windows displaying one target object, thereby achieving an effect of simultaneously displaying two or more target objects.

Further, the multi-window browsing device can also include a counter 505, a closing unit 507, and/or an adjusting unit 509.

The counter 505 can be used to count the number of selectively added target objects and obtain the number of the selectively added target objects. The number of counts of the counter 505 can be the number of the selected target objects. For example, in the case where the target objects are web pages, the number of counts of the counter is initially set to be 0. Every time a target object (e.g., a web page in this case) is selectively added, the number of counts of the counter can be increased by 1. In an example where a total of two target web pages are added, the number of counts of the counter can be 2. In this manner, by obtaining the number of counts of the counter 505, the determining unit 502 can know that the number of the selectively added target objects is 2.

When a control command for closing the multi-window browsing interface is received, the closing unit 507 can be used to close the currently displayed multi-window browsing interface, restore original browsing interfaces of the target objects, and clear the counter 505.

In an example of FIG. 4, when a control command, generated by a user by touching the exit button 405 of the multi-window browsing interface and/or by other triggering methods, is received, the closing unit 507 can close the currently displayed multi-window browsing interface 400 and restore original browsing interfaces of the target objects. When the target objects are web pages, after the closing unit 507 closes the currently displayed multi-window browsing interface 400, each of the web pages can be restored to its original single web page display interface in the browser and each of the web pages can be listed as a visible tab for a user to select. When a user selects a tab, a window can be displayed. The user can only perform browsing operation(s) with respect to one window that is currently displayed.

When an interface adjustment control command is received, the adjusting unit 509 can be used to adjust widths of windows displayed on the multi-window browsing interface.

Still using FIG. 4 as an example, when the adjusting unit 509 receives an interface adjustment control command that is generated by a user by pressing a tab 403 at a border between the two browsing windows 401 and 402 and dragging the tab 403 left or right, the adjusting unit 509 can accordingly adjust displaying widths of the two browsing windows 401 and 402.

In the embodiment of the present disclosure, when the number of selectively added target objects has reached a preset value, the multi-window browsing interface can be started and the selectively added target objects can be simultaneously displayed on the multi-window browsing interface. This allows a user to simultaneously manage multiple browsing windows and simultaneously perform relevant browsing operations with respect to multiple windows. For example, a user can play a video in one window and at the same time browse a web page in another window. This is more user-friendly.

In various embodiments, the disclosed modules can be configured in one apparatus or configured in multiple apparatus as desired. The modules disclosed herein can be integrated in one module or in multiple modules. Each of the modules disclosed herein can be divided into one or more sub-modules, which can be recombined in any manner.

One of ordinary skill in the art would appreciate that suitable software and/or hardware (e.g., a universal hardware platform) may be included and used in the disclosed methods and systems. For example, the disclosed embodiments can be implemented by hardware only, which alternatively can be implemented by software products only. The software products can be stored in a computer-readable storage medium including, e.g., ROM/RAM, magnetic disk, optical disk, etc. The software products can include suitable commands to enable a terminal device (e.g., including a mobile phone, a personal computer, a server, or a network device, etc.) to implement the disclosed embodiments.

The embodiments disclosed herein are exemplary only. Other applications, advantages, alternations, modifications, or equivalents to the disclosed embodiments are obvious to those skilled in the art and are intended to be encompassed within the scope of the present disclosure.

### INDUSTRIAL APPLICABILITY AND ADVANTAGEOUS EFFECTS

Without limiting the scope of any claim and/or the specification, examples of industrial applicability and certain advantageous effects of the disclosed embodiments are listed for illustrative purposes. Various alternations, modifications, or equivalents to the technical solutions of the disclosed embodiments can be obvious to those skilled in the art and can be included in this disclosure.

Multi-window browsing methods and devices are provided herein. A target-object selection control command can be received by a multi-window browsing device. The target-object selection control command can be issued according to each of one or more target objects selected to be added to a multi-window browsing interface. The multi-window browsing device can determine whether a number of the one or more target objects reaches a preset value and can start the multi-window browsing interface to simultaneously display the one or more target objects on the multi-window browsing interface, when the number of the one or more target objects is determined that reaches the preset value. An exemplary multi-window browsing device can include a receiving unit, a determining unit, and a display unit.

In this manner, when the number of selectively added target objects has reached the preset value, the multi-window browsing interface can be started and the selectively added target objects can be simultaneously displayed on the multi-window browsing interface. This allows a user to simultaneously manage multiple browsing windows and simultaneously perform relevant browsing operations with respect to multiple windows. For example, a user can play a video in one window and at the same time browse a web page in another window. This is more user-friendly.

What is claimed is:

1. A multi-window browsing method comprising:
receiving, by a multi-window browsing device, a target-object selection control command, wherein the target-object selection control command is issued according to each of one or more target objects selected to be added to a multi-window browsing interface;
determining, by the multi-window browsing device, whether a number of the one or more target objects reaches a preset value; and
starting, by the multi-window browsing device, the multi-window browsing interface and simultaneously displaying the one or more target objects on the multi-window browsing interface, when the number of the one or more target objects is determined that reaches the preset value.

2. The method of claim 1, wherein the receiving of the target-object selection control command further comprises:
obtaining the number of the one or more target objects using a counter to count how many target objects are in the one or more target objects.

3. The method of claim 2, further comprising:
closing the multi-window browsing interface that is currently displayed, when receiving a control command for closing the multi-window browsing interface,
restoring original browsing interfaces of the one or more target objects, and
clearing the counter.

4. The method of claim 1, wherein the one or more target objects that are selectively added to the multi-window browsing interface comprise objects selected from a multi-tab list, a website guide, quick links, or links in a web page.

5. The method of claim 1, wherein, after the number of the one or more target objects is determined that reaches the preset value, the method further comprises:
adjusting widths of windows displayed on the multi-window browsing interface, when an interface adjustment control command is received.

6. A multi-window browsing device comprising:
a receiving unit, configured to receive a target-object selection control command, wherein the target-object selection control command is issued by a control unit according to each of one or more target objects selected to be added to a multi-window browsing interface;
a determining unit, configured to determine whether a number of the one or more target objects reaches a preset value; and
a display unit, configured to start the multi-window browsing interface and to simultaneously display the one or more target objects on the multi-window browsing interface, when the number of the one or more target objects is determined that reaches the preset value.

7. The device of claim 6, further comprising a counter configured to obtain the number of the one or more target objects by counting how many target objects are in the one or more target objects.

8. The device of claim 7, further comprising a closing unit configured to:
close the multi-window browsing interface that is currently displayed, when receiving a control command for closing the multi-window browsing interface,
restore original browsing interfaces of the one or more target objects, and
clear the counter.

9. The device of claim 6, further comprising an adjusting unit configured to adjust widths of windows displayed on the multi-window browsing interface, when an interface adjustment control command is received.

10. The device of claim 6, wherein the one or more target objects that are selectively added to the multi-window browsing interface comprise objects selected from a multi-tab list, a website guide, quick links, or links in a web page.

11. The device of claim 6, wherein the multi-window browsing device comprises a mobile terminal.

12. The device of claim 6, wherein the multi-window browsing device comprises a personal computer, a notebook computer, a car computer, a server computer, a hand-held computing device, a point of sale (POS) device.
